(19) United States
(12) Patent Application Publication
(10) Pub. No.: US 2013/0093699 A1
(43) Pub. Date: Apr. 18, 2013

(54) TOUCH PANEL

(71) Applicants: Jinuk Lee, Gyunggi-do (KR); Sang Su Hong, Gyunggi-do (KR); Woo Jin Lee, Gyunggi-do (KR); Dong Hwan Lee, Gyunggi-do (KR)

(72) Inventors: Jinuk Lee, Gyunggi-do (KR); Sang Su Hong, Gyunggi-do (KR); Woo Jin Lee, Gyunggi-do (KR); Dong Hwan Lee, Gyunggi-do (KR)

(73) Assignee: SAMSUNG ELECTRO-MECHANICS CO., LTD., Gyunggi-do (KR)

(21) Appl. No.: 13/572,743

(22) Filed: Aug. 13, 2012

(30) Foreign Application Priority Data
Oct. 13, 2011 (KR) 10-2011-0104650

(51) Int. Cl. G06F 3/041

(52) U.S. Cl. 345/173

(57) ABSTRACT

Disclosed herein is a touch panel. The touch panel 100 according to the present invention includes electrode patterns 110 disposed in parallel with each other in a first direction (A), wherein the electrode patterns are provided with opening portions 120 dividing the electrode patterns 110 into two portions, the opening portions 120 having a configuration 125 in which the opening portion moves N times in the first direction (A) while going to a second direction (B) that is vertical to the first direction (A), the configuration 125 being repeated M times. The touch panel allows the electrode patterns to have a single-layer structure by adopting the opening portions 120 in the electrode patterns 110, thereby making it possible to reduce the manufacturing costs of the touch panel and simplify the manufacturing process thereof.

### CROSS REFERENCE TO RELATED APPLICATION

This application claims the benefit of Korean Patent Application No. 10-2011-0104650, filed on Oct. 13, 2011, entitled “Touch Panel”, which is hereby incorporated by reference in its entirety into this application.

### BACKGROUND OF THE INVENTION

1. Technical Field

The present invention relates to a touch panel.

2. Description of the Related Art

Alongside the growth of computers using digital technology, devices assisting computers have also been developed, and personal computers, portable transmitters and other personal information processors execute processing of text and graphics using a variety of input devices such as a keyboard and a mouse.

While the rapid advancement of the information-based society has been widening the use of computers more and more, there have been occurring the problems of it being difficult to efficiently operate products using only the keyboard and mouse as being currently responsible for the input device function. Thus, the demand for a device that is simple, has minimum malfunction, and has the capability to easily input information is increasing.

Furthermore, current techniques for input devices exceed the level of fulfilling general functions and thus are progressing towards techniques related to high reliability, durability, innovation, designing and manufacturing. To this end, a touch panel has been developed as an input device capable of inputting information such as text and graphics.

The touch panel is mounted on the display surface of an image display device such as an electronic organizer, a flat panel display including a liquid crystal display (LCD), a plasma display panel (PDP), an electroluminescence (El) element or the like, or a cathode ray tube (CRT), so that a user selects the information desired while viewing the image display device.

The touch panel is classifiable as a resistive type, a capacitive type, an electromagnetic type, a surface acoustic wave (SAW) type, and an infrared type. The type of touch panel selected is one to that is adapted for an electronic product in consideration of not only signal amplification problems, resolution differences and the degree of difficulty of designing and manufacturing technology but also in light of optical properties, electrical properties, mechanical properties, resistance to the environment, input properties, durability and economic benefits of the touch panel. In particular, resistive and capacitive types are prevalently used in a broad range of fields currently.

However, in order to recognize touched coordinates, a touch panel according to the prior art should be provided with double-layer electrode patterns. For example, as disclosed in Korean Patent Publication No. 10-0921709, a touch panel is provided with first transparent electrode patterns and second transparent electrode patterns orthogonal with each other. As such, since the touch panel according to the prior art should be provided with the double-layer electrode patterns, the manufacturing costs are increased and the manufacturing process is complicated, and furthermore, the thickness thereof becomes thick to thereby be difficult in making the touch panel thin.

### SUMMARY OF THE INVENTION

The present invention has been made in an effort to provide a touch panel having opening portions provided in electrode patterns to thereby allow the electrode patterns to have a single-layer structure.

According to a preferred embodiment of the present invention, there is provided a touch panel, including: electrode patterns disposed in parallel with each other in a first direction, wherein the electrode patterns are provided with opening portions each dividing the electrode pattern into two portions and the opening portion has a configuration in which the opening portion moves N times in the first direction while going to a second direction that is vertical to the first direction, the configuration being repeated M times.

The touch panel may further include a control unit determining whether the electrode patterns are touched while going to the second direction, the control unit sequentially determining a data value to be “1” when a touch is input to a first electrode pattern and sequentially determining a data value to be “0” when a touch is not input to the first electrode pattern, while going to the second direction, to thereby calculate M first unit data including N data values from the left to the right, and sequentially determining a data value to be “1” when a touch is input to a second electrode pattern and sequentially determining a data value to be “0” when a touch is not input to the second electrode pattern, while going to the second direction, to thereby calculate M second unit data including N data values from the left to the right, wherein the electrode pattern may include: a first electrode pattern provided at one side based on the opening portion; and a second electrode pattern provided at the other side based on the opening portion.

When at least one of the data values of the positions corresponding to each other in the M first unit data and the M second unit data is “1”, the control unit may determine the data value to be “1” and when all of the data values of the positions corresponding to each other therein are “0”, the control unit may determine the data value to be “0”, thereby calculating M third unit data including N data values from the left to the right, and the control unit may recognize coordinates of the touch in the second direction based on an intermediate position of “1” in the data value of the M third unit data.

When at least one of the data values of the positions corresponding to each other in each of the first unit data is “1”, the control unit may determine the data value to be “1” and when all of the data values of the positions corresponding to each other therein are “0”, the control unit may determine the data value to be “0”, thereby calculating fourth unit data including N data values from the left to the right, when at least one of the data values of the positions corresponding to each other in each of the second unit data is “1”, the control unit may determine the data value to be “1” and when all of the data values of the positions corresponding to each other therein are “0”, the control unit may determine the data value to be “0”, thereby calculating fifth unit data including N data values from the left to the right, and the control unit may recognize the coordinates of the touch in the first direction based on the number of “0s” from the left in the data value of the fourth unit data and the number of “1s” from the left in the data value of the fifth unit data.

The control unit may calculate Y1 by adding a predetermined value to the number of “0s” from the left in the data values of the fourth unit data, and calculate Y2 by adding a predetermined value to the number of “1s” from the left in the data values of the fifth unit data, thereby recognizing the coordinates of the touch in the first direction based on an average value of the Y1 and the Y2.

The predetermined value may be 0.5.

The electrode patterns may include straight lines disposed in parallel with each other.

The electrode patterns may include first straight lines disposed in parallel with each other and second straight lines formed to be vertical to the first straight lines at a predetermined interval along the first straight lines.

The electrode patterns may include zigzag type lines disposed in parallel with each other.

The electrode patterns may include a combination of two zigzag type lines disposed in parallel with each other.

The touch panel may further include: a control unit provided on a transparent substrate; and electrode wirings connecting the electrode patterns and the control unit to each other, wherein the electrode patterns may be provided on the transparent substrate.

The control unit may include a first controller provided at one side of the electrode patterns and a second controller provided at the other side of the electrode patterns, and the electrode wirings may include first electrode wirings connecting one end of the electrode patterns to the first controller and second electrode wirings connecting the other end of the electrode patterns to the second controller.

### BRIEF DESCRIPTION OF THE DRAWINGS

FIGS. 1 and 2 are plan views of a touch panel according to a preferred embodiment of the present invention;

FIGS. 3A to 3C are enlarged plan views of the modified examples of the electrode patterns of FIG. 1;

FIG. 4 is a plan view showing a process in which a touch panel according to a preferred embodiment of the present invention recognizes touched coordinates; and

FIGS. 5A to 5C are plan views additionally showing a process in which a touch panel according to a preferred embodiment of the present invention recognizes touched coordinates.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, and so on are used to distinguish one element from another element, and the elements are not defined by the above terms. Further, in describing the present invention, a detailed description of related known functions or configurations will be omitted so as not to obscure the subject of the present invention.

Hereinafter, preferred embodiments of the present invention will be described in detail with reference to the accompanying drawings.

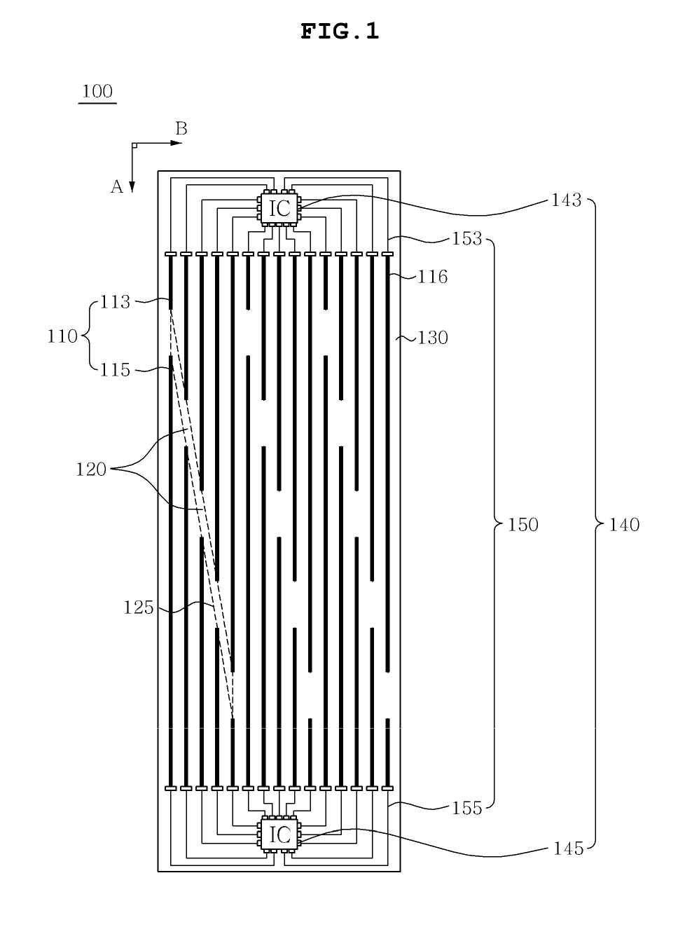

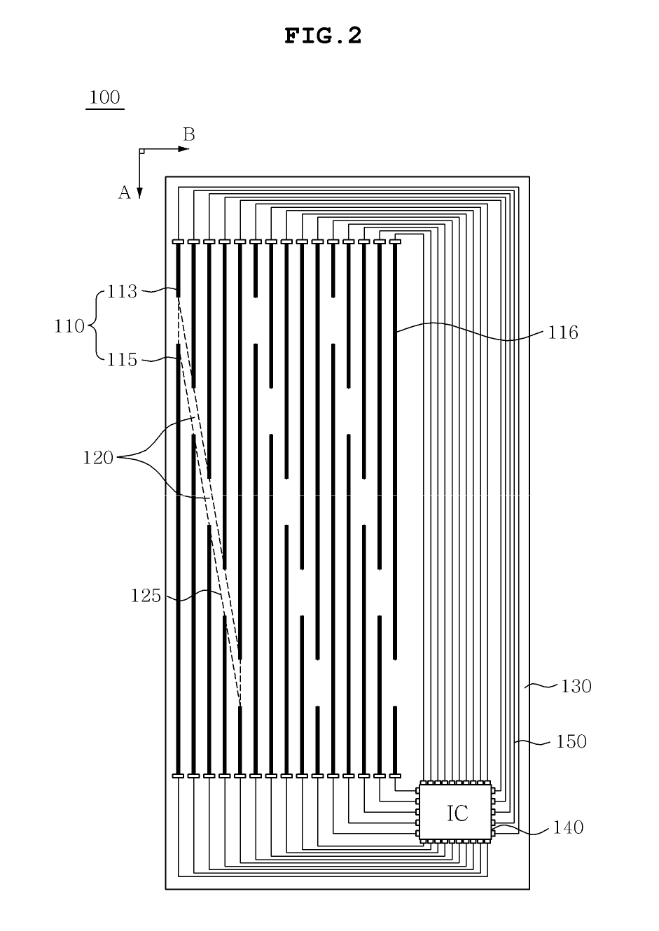

FIGS. 1 and 2 are plan views of a touch panel according to a preferred embodiment of the present invention.

As shown in FIGS. 1 and 2, a touch panel 100 according to the present embodiment of the present invention includes electrode patterns 110 disposed in parallel with each other in a first direction (A), wherein the electrode patterns 110 are provided with opening portions 120 dividing the electrode patterns 110 into two portions, the opening portions 120 having a configuration 125 in which the opening portion moves N times in the first direction (A) while going to a second direction (B) that is vertical to the first direction (A), the configuration 125 being repeated M times.

The electrode patterns 110, which serve to generate signals when the touch panel is touched by a user to allow a control unit 140 to recognize the touched coordinates, are disposed in parallel with each other in the first direction (A). Here, the electrode pattern 110 may be made of copper (Cu), aluminum (Al), gold (Au), silver (Ag), titanium (Ti), palladium (Pd), chrome (Cr), or a combination thereof More specifically, the electrode pattern 110 may preferably be made of copper (Cu), aluminum (Al), gold (Au), and silver (Ag), which have high electric conductivity, but may also be made of all metals having electric conductivity. In addition, when the electrode pattern 110 is made of copper (Cu), a surface of the electrode pattern 110 may be subjected to a black oxide process. Here, the black oxide process refers to a process of oxidizing a surface of the electrode pattern 110 to thereby precipitate Cu₂O or CuO, wherein Cu₂O is colored brown to thereby be named brown oxide and CuO is colored black to thereby be named black oxide. As described above, the surface of the electrode pattern 110 is subjected to the black oxide process, thereby making it possible to prevent light from being reflected on the electrode pattern and thus improve visibility of the touch panel 100. Meanwhile, besides the above metals, the electrode pattern 110 may be made of metal oxides such as silver obtained by exposing and developing a silver halide emulsion layer, indium tin oxide (ITO), and the like, or conductive polymers having excellent flexibility and simple coating process such as PEDOT/PSS and the like.

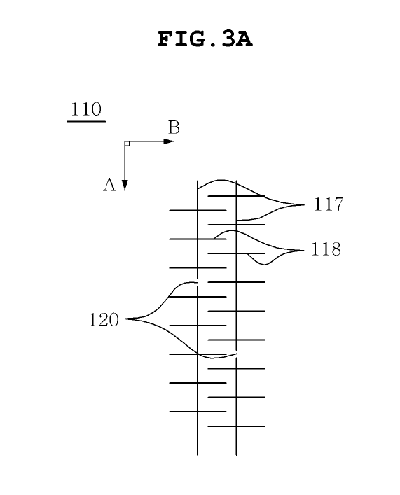

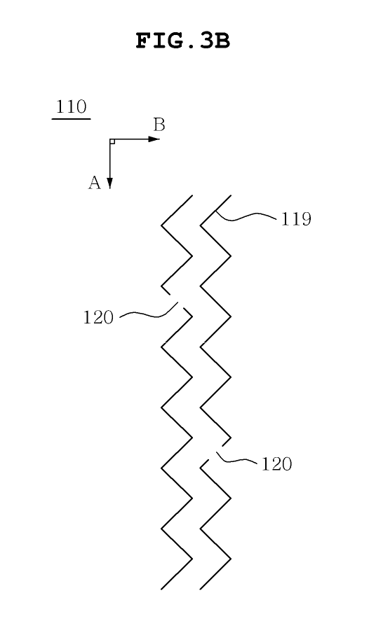

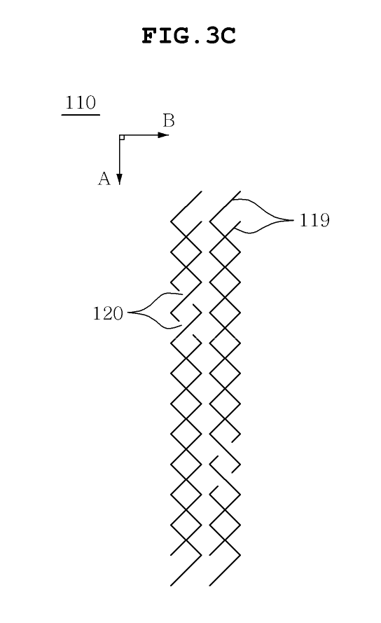

In addition, the electrode patterns 110 are basically configured of straight lines 116 disposed in parallel with each other in the first direction (A). Furthermore, in order to improve sensitivity of the touch panel 100 by increasing capacitance, as shown in FIG. 3A, the electrode patterns 110 may be configured of first straight lines 117 disposed in parallel with each other in the first direction (A) and second straight lines 118 formed to be vertical to the first straight lines 117 at a predetermined interval along the first straight lines 117. Alternatively, as shown in FIG. 3B or 3C, the electrode patterns 110 may be configured of zigzag type lines 119 disposed in parallel with each other (see FIG. 3B) or be configured of a combination of two zigzag type lines 119 disposed in parallel with each other (see FIG. 3C).

Meanwhile, the electrode patterns 110 are provided with the opening portions 120 (see FIGS. 1 and 2). Here, the opening portion 120 divides the electrode pattern 110 into two portions. The opening portion 120 has a configuration 125 in which the opening portion moves N times in the first direction (A) while going to the second direction (B) (that is, being vertical to the first direction (A)), the configuration 125 being repeated M times. For example, as shown in FIG. 1, the opening portion 120 has a configuration 125 in which the opening portion moves five times in the first direction (A) while going to the second direction (B), the configuration 125 being repeated three times. Therefore, the positions of the opening portions 120 are repeated in a unit of five opening portions based on the second direction (B), and an A^{th} opening portion 120 has the same coordinate as an A+5^{th} opening portion 120 in view of the first direction (A). The configuration 125 of the opening portion 120 is for sensing the touched coordinates in the first direction (A), wherein the interval made while the opening portion 120 moves in the first direction (A) may be constantly designed. A detailed description thereof will be described later.

In addition, the electrode patterns 110 are formed on a transparent substrate 130. Here, the transparent substrate 130 needs to be provided with supporting force capable of supporting the electrode patterns 110 and transparency allowing a user to recognize an image provided from an image display apparatus. In consideration of the supporting force and the transparency, the transparent substrate 130 may be made of polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC) film, polyvinyl alcohol (PVA) film, polyimide (PI) film, polystyrene (PS), biaxially oriented polystyrene (BOPS; containing K resin), glass or tempered glass, and so on, but is not particularly limited thereto.

Meanwhile, the electrode pattern 110 may be connected to a controller that is a type of a control unit 140 by electrode wirings 150. In this case, the control unit 140 may be separately provided, apart from the transparent substrate 130, to thereby be connected to the electrode patterns by flexible printed cable (FPC) or be provided on the transparent substrate 130 as shown in FIG. 1. When the control unit 140 is provided on the transparent substrate 130, the control unit 140 may be connected to the electrode wirings 150 using a wire bonding scheme or a ball grid array (BGA) scheme. More specifically, as shown in FIG. 1, the control unit 140 may include a first controller 143 provide at one side of the electrode pattern 110 and a second controller 145 provided at the other side of the electrode pattern 110. In this case, the electrode wiring 150 may include a first electrode wiring 153 connecting one end of the electrode pattern 110 to the first controller 143 and a second electrode wiring 155 connecting the other end of the electrode pattern 110 to the second controller 145. As such, the first controller 143 and the second controller 145 are disposed at both sides of the electrode patterns 110, and the first controller 143 and the second controller 145 are each connected to both ends of the electrode patterns 110 through the electrode wirings 150, such that there is no need to extend the electrode wirings 150 to right and left sides of the electrode patterns 110. Therefore, a bezel area at the right and left sides of the electrode patterns 110 may be minimized. A case in which the first controller 143 and the second controller 145 are disposed at both sides of the electrode patterns 110 is exemplified, but the scope of the right of the present invention is not limited thereto and thus, one control unit 140 may also be provided as shown in FIG. 2.

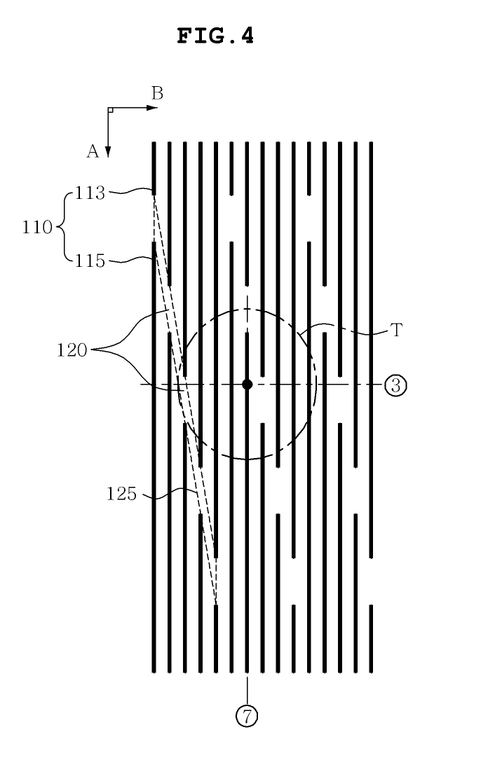

FIG. 4 is a plan view showing a process in which a touch panel according to a preferred embodiment of the present invention recognizes touched coordinates. A process of sensing touched coordinates in the touch panel 100 will be described with reference to FIG. 4.

First, the electrode pattern 110 is configured of a first electrode pattern 113 provided at one side based on the opening portion 120 and a second electrode pattern 115 provided at the other side based thereon. In this case, the opening portion 120 has the configuration 125 in which the opening portion moves N times in the first direction (A) while going to the second direction (B), the configuration being repeated M times. Therefore, the first electrode pattern 113 may have a configuration in which the first electrode pattern 113 is lengthened up to Nth while going to the second direction (B), the configuration being repeated M times, and the second electrode pattern 115 may have a configuration in which the second electrode pattern 115 is shortened up to N^{th} while going to the second direction (B), the configuration being repeated M times.

For example, as shown in FIG. 4, the opening portion 120 may have a configuration 125 in which the opening portion moves five times in the first direction (A) while going to the second direction (B), the configuration 125 being repeated three times. A process of sensing, by the control unit 140, the touched coordinates based on the configuration 125 will be described.

Basically, the control unit 140 sequentially determines whether the electrode patterns 110 are touched while going to the second direction (B). More specifically, the control unit 140 sequentially determines a data value to be “1” when a touch is input to the first electrode pattern 113 and sequentially determines a data value to be “0” when a touch is not input to the first electrode pattern 113, while going to the second direction (B), thereby calculating three first unit data including five data values from the left to the right. Therefore, when a touch T is input as shown in FIG. 4, the three first unit data become <(00111) (00111) (00000)>. In addition, the control unit 140 sequentially determines a data value to be “1” when a touch is input to the second electrode pattern 115 and sequentially determines a data value to be “0” when a touch is not input to the second electrode pattern 115, while going to the second direction (B), thereby calculating three second unit data including five data values from the left to the right. Therefore, when a touch T is input as shown in FIG. 4, the three second unit data become <(00000) (11100) (10000)>.

The control unit 140 may recognize the coordinate of the touch T in the first direction (A) and the coordinate of the touch T in the second direction (B) based on the calculated M first unit data and M second unit data.

In order to recognize the coordinate of the touch T in the second direction (B), the control unit 140 first compares data values of the positions corresponding to each other (data values having the same sequence from the left) in the M first unit data and the M second unit data. More specifically, when at least one of the data values of the positions corresponding to each other is “1”, the control unit 140 determines the data value to be “1” and when all of the data values of the positions corresponding to each other are “0”, the control unit 140 determines the data value to be “0”, thereby calculating three third unit data including five data values from the left to the right. Here, three first unit data become <(00111) (00111) (00000)> and three second unit data become <(00000) (11100) (10000)>, such that three third unit data become <(00111) (11111) (10000)>. In this case, the coordinate of the touch T in the second direction (B) may be recognized as an intermediate position of “1” in the data values of the three third unit data. In actual, the three third unit data are <(00111) (11111) (10000)> and the intermediate position of “1” among them is the 7^{th} position, such that the coordinate of the touch T in the second direction B may be recognized as 7.

Meanwhile, in order to recognize the coordinate of the touch T in the first direction (A), the control unit 140 first compares data values of the positions corresponding to each other (data having the same sequence from the left) in each of the first unit data. More specifically, when at least one of the data values of the positions corresponding to each other is “1”, the control unit 140 determines the data value to be “1” and when all of the data values of the positions corresponding to each other are “0”, the control unit 140 determines the data value to be “0”, thereby calculating fourth unit data including five data values from the left to the right. In actual, the three first unit data are <(00111) (00111) (00000)>, such that the fourth unit data becomes <00111>.

In addition, the control unit 140 compares data values of the positions corresponding to each other (data values having the same sequence from the left) in each of the second unit data. More specifically, when at least one of the data values of the positions corresponding to each other is “1”, the control unit 140 determines the data value to be “1” and when all of the data values of the positions corresponding to each other are “0”, the control unit 140 determines the data value to be “0”, thereby calculating fifth unit data including five data values from the left to the right. In actual, the three second unit data are <(00000) (11100) (10000)>, such that the fifth unit data becomes <11100>.

Thereafter, the control unit 140 may recognize the coordinate of the touch T in the first direction (A) based on the number of “0s” from the left in the data values of the fourth unit data and the number of “1s” from the left in the data values of the fifth unit data. More specifically, Y1 is calculated by adding a predetermined value (for example, 0.5) to the number of “0s” from the left in the data values of the fourth unit data, and Y2 is calculated by adding a predetermined value (for example, 0.5) to the number of “1s” from the left in the data values of the fifth unit data, and thereafter, an average value of Y1 and Y2 is calculated. In actual, the number of “0s” from the left in the data values (<00111>) of the fourth unit data is two, such that Y1 becomes 2.5 (2+0.5=2.5); and the number of “1s” from the left in the data values (<11100>) of the fifth unit data is three, such that Y2 becomes 3.5 (3+0.5=3.5). Finally, an average value of Y1 and Y2 becomes 3 ((2.5+3.5)/2=3), such that the coordinate of the touch T in the first direction (A) may be recognized as 3.

However, a case in which the predetermined value is defined as 0.5 is exemplified, such that a predetermined value may also be varied according to a design of the touch panel 100.

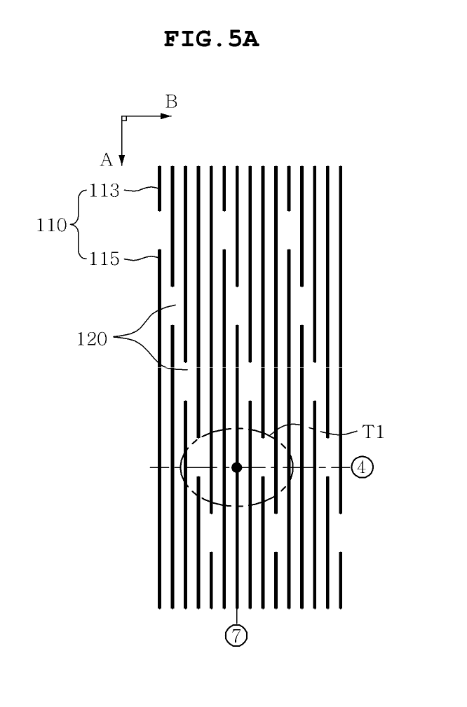

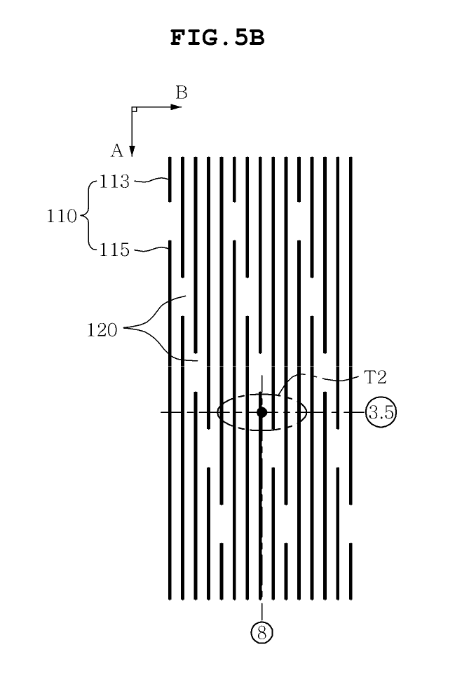

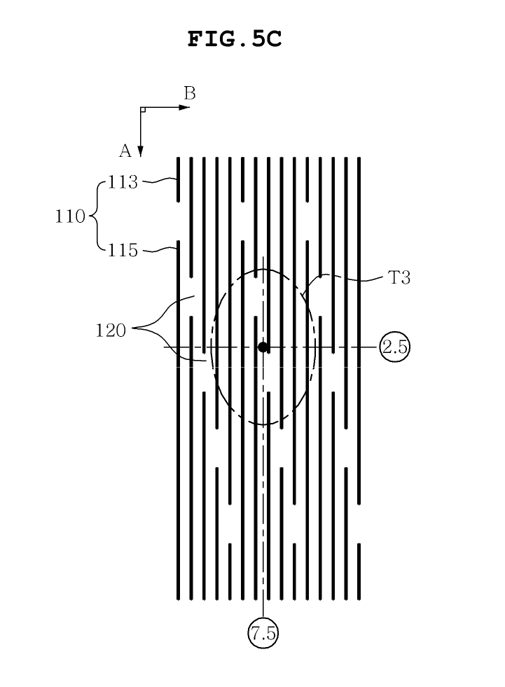

Meanwhile, FIGS. 5A to 5C are plan views additionally showing a process in which a touch panel according to a preferred embodiment of the present invention recognizes touched coordinates. A process of sensing touched coordinates in the touch panel 100 will be described with reference to FIGS. 5A to 5C.

First, when a touch T1 is input as shown in FIG. 5A, three first unit data become <(00011) (00011) (00000)> and three second unit data become <(00110) (11110) (10000)>. Therefore, three third unit data become <(00111) (11111) (10000)> and the intermediate position of “1” among them is the 7^{th} position, such that the coordinate of the touch T1 in the second direction B may be recognized as 7. Meanwhile, fourth unit data becomes <00011>, such that Y1 becomes 3.5; and fifth unit data becomes <11110>, such that Y2 becomes 4.5. Finally, an average value of Y1 and Y2 becomes 4 ((3.5+4.5)/2=4), such that the coordinate of the touch T1 in the first direction (A) may be recognized as 4.

Next, when a touch T2 is input as shown in FIG. 5B, three first unit data become <(00001) (00011) (00000)> and three second unit data become <(00000) (11100) (10000)>. Therefore, three third unit data become <(00001) (11111) (10000)> and the intermediate position of “1” among them is the 8^{th} position, such that the coordinate of the touch T2 in the second direction B may be recognized as 8. Meanwhile, fourth unit data becomes <00011>, such that Y1 becomes 3.5; and fifth unit data becomes <11100>, such that Y2 becomes 3.5. Finally, an average value of Y1 and Y2 becomes 3.5 ((3.5++3.5)/2=3.5), such that the coordinate of the touch T2 in the first direction (A) may be recognized as 3.5.

Next, when a touch T3 is input as shown in FIG. 5C, three first unit data become <(00011) (01111) (00000)> and three second unit data become <(00000) (11100) (10000)>. Therefore, three third unit data become <(00111) (11111) (10000)> and the intermediate position of “1” among them is the 7.5^{th} position, such that the coordinate of the touch T3 in the second direction B may be recognized as 7.5. Meanwhile, fourth unit data becomes <01111>, such that Y1 becomes 1.5; and fifth unit data becomes <11100>, such that Y2 becomes 3.5. Finally, an average value of Y1 and Y2 becomes 2.5 ((1.5+3.5)/2=2.5), such that the coordinate of the touch T3 in the first direction (A) may be recognized as 2.5.

As described above, when a configuration 125 in which the opening portion 120 moves five times in the first direction (A) while going to the second direction (B) (see FIG. 4) is repeated three times, the number of the coordinates of the touch in the first direction (A) may be eleven from 0.5 to 5.5 in a unit of 0.5. However, the configuration 125 of the opening portion 120 is exemplified. The number of the touched coordinates may be adjusted by adjusting the number of the electrode patterns 110 and the opening portions 120, whereby the sensitivity of the touch panel 100 may be controlled.

According to the present invention, the electrode patterns may have a single-layer structure by adopting the opening portions in the electrode patterns, thereby making it possible to reduce the manufacturing costs of the touch panel and simplify the manufacturing process thereof.

In addition, according to the present invention, the electrode patterns have a single-layer structure to reduce a thickness of the touch panel, thereby making it possible to make the touch panel thin.

Although the preferred embodiments of the present invention have been disclosed for illustrative purposes, they are for specifically explaining the present invention and thus a touch panel according to the present invention is not limited thereto, but those skilled in the art will appreciate that various modifications, additions and substitutions are possible, without departing from the scope and spirit of the invention as disclosed in the accompanying claims. Accordingly, any and all modifications, variations or equivalent arrangements should be considered to be within the scope of the invention, and the detailed scope of the invention will be disclosed by the accompanying claims.

What is claimed is:

1. A touch panel, comprising electrode patterns disposed in parallel with each other in a first direction,
wherein the electrode patterns are provided with opening portions each dividing the electrode pattern into two portions and the opening portion has a configuration in which the opening portion moves N times in the first direction while going to a second direction that is vertical to the first direction, the configuration being repeated M times.

2. The touch panel as set forth in claim 1, further comprising a control unit determining whether the electrode patterns are touched while going to the second direction, the control unit sequentially determining a data value to be “1” when a touch is input to a first electrode pattern and determining a data value to be “0” when a touch is not input to the first electrode pattern, while going to the second direction, to thereby calculate M first unit data including N data values from the left to the right, and sequentially determining a data value to be “1” when a touch is input to a second electrode pattern and sequentially determining a data value to be “0” when a touch is not input to the second electrode pattern, while going to the second direction, to thereby calculate M second unit data including N data values from the left to the right,
wherein the electrode pattern includes:
a first electrode pattern provided at one side based on the opening portion; and
a second electrode pattern provided at the other side based on the opening portion.

3. The touch panel as set forth in claim 2, wherein when at least one of the data values of the positions corresponding to each other in the M first unit data and the M second unit data is “1”, the control unit determines the data value to be “1” and when all of the data values of the positions corresponding to each other therein are “0”, the control unit determines the data value to be “0”, thereby calculating M third unit data including N data values from the left to the right, and the control unit recognizes coordinates of the touch in the second direction based on an intermediate position of “1” in the data value of the M third unit data.

4. The touch panel as set forth in claim 2, wherein when at least one of the data values of the positions corresponding to each other in each of the first unit data is “1”, the control unit determines the data value to be “1” and when all of the data values of the positions corresponding to each other therein are “0”, the control unit determines the data value to be “0”, thereby calculating fourth unit data including N data values from the left to the right,
when at least one of the data values of the positions corresponding to each other in each of the second unit data is “1”, the control unit determines the data value to be “1” and when all of the data values of the positions corresponding to each other therein are “0”, the control unit determines the data value to be “0”, thereby calculating fifth unit data including N data values from the left to the right, and
the control unit recognizes the coordinates of the touch in the first direction based on the number of “0s” from the left in the data value of the fourth unit data and the number of “1s” from the left in the data value of the fifth unit data.

5. The touch panel as set forth in claim 4, wherein the control unit calculates Y1 by adding a predetermined value to the number of “0s” from the left in the data values of the fourth unit data, and calculates Y2 by adding a predetermined value to the number of “1s” from the left in the data values of the fifth unit data, thereby recognizing the coordinates of the touch in the first direction based on an average value of the Y1 and the Y2.

6. The touch panel as set forth in claim 5, wherein the predetermined value is 0.5.

7. The touch panel as set forth in claim 1, wherein the electrode patterns include straight lines disposed in parallel with each other.

8. The touch panel as set forth in claim 1, wherein the electrode patterns include first straight lines disposed in parallel with each other and second straight lines formed to be vertical to the first straight lines at a predetermined interval along the first straight lines.

9. The touch panel as set forth in claim 1, wherein the electrode patterns include zigzag type lines disposed in parallel with each other.

10. The touch panel as set forth in claim 1, wherein the electrode patterns include a combination of two zigzag type lines disposed in parallel with each other.

11. The touch panel as set forth in claim 1, further comprising:
a control unit provided on a transparent substrate; and
electrode wirings connecting the electrode patterns and the control unit to each other,
wherein the electrode patterns are provided on the transparent substrate.

12. The touch panel as set forth in claim 11, wherein the control unit includes a first controller provided at one side of the electrode patterns and a second controller provided at the other side of the electrode patterns, and
the electrode wirings include first electrode wirings connecting one end of the electrode patterns to the first controller and second electrode wirings connecting the other end of the electrode patterns to the second controller.
